(19) United States
(12) Patent Application Publication
(10) Pub. No.: US 2024/0039814 A1
(43) Pub. Date: Feb. 1, 2024

(54) COMMUNICATION SYSTEM, COMMUNICATION QUALITY MEASURING METHOD, GATEWAY DEVICE AND PROGRAM

(71) Applicant: NIPPON TELEGRAPH AND TELEPHONE CORPORATION, Tokyo (JP)

(72) Inventors: Tatsuya FUKUI, Musashino-shi, Tokyo (JP); Katsuya MINAMI, Musashino-shi, Tokyo (JP); Yuki SAKAUE, Musashino-shi, Tokyo (JP)

(73) Assignee: NIPPON TELEGRAPH AND TELEPHONE CORPORATION, Tokyo (JP)

(21) Appl. No.: 18/020,187

(22) PCT Filed: Aug. 14, 2020
(86) PCT No.: PCT/JP2020/030911

§ 371 Date: Feb. 7, 2023

(51) Int. Cl. H04L 43/08; H04L 43/12

(52) U.S. Cl. CPC H04L 43/08; H04L 43/12

(57) ABSTRACT

An object of the present disclosure is to continuously and easily grasp a communication quality such as RTT of application communication itself without depending on a protocol type.

A communication system of the present disclosure holds a DPI rule for each application in a DPI rule management server in advance, duplicates a packet of a designated application extracted based on a filtering rule for extracting the packet, extracts information from the packet based on a DPI rule for the application acquired from the DPI rule management server, and calculates a communication quality based on the extracted information.

### TECHNICAL FIELD

The present disclosure relates to a system that measures the communication quality of an application using communication.

### BACKGROUND ART

With the spread of bidirectional applications such as eSports and remote control, there is an increasing demand for knowing the communication quality of communication of an application (hereinafter, the application may be referred to as an application, and the communication thereof may be referred to as application communication) between a user terminal and a server. As a method of acquiring the communication quality of the application communication, the following methods can be considered: a first method (see, for example, Non Patent Literature 1) of executing a ping command for confirming communication from the user terminal to the server and measuring the communication quality; a second method (see, for example, Non Patent Literature 2) of providing the user terminal with the communication quality acquired by the server side in the application; and a third method of acquiring and analyzing a capture of the communication traffic. In the third method, the communication quality is measured by deep packet inspection (DPI), which reads a header in a payload specified in an application layer.

However, these methods have the following problems.

Since what is obtained by the first method is only a round trip time (RTT) of a ping packet at the moment of executing the ping command, there are problems that an RTT of the application communication itself is not measured and that the RTT during the time when the application is being executed cannot be obtained in time series.

In the case of the second method, the RTT of the application communication itself can be measured, but there is a problem that an instantaneous variation of the communication quality cannot be detected because the communication quality is only displayed every one second to several seconds.

In the case of the third method, it is possible to continuously and objectively measure the RTT of the application communication itself in a correct form. However, in a case where the header information is generally an application as in the transmission control protocol (TCP), it is necessary to construct a mechanism for measuring the RTT after a user grasps the positions of a sequence number and an ACK number on each of packets for measuring the RTT, which is very complicated. Since the structures of these packets are different for each application, it is necessary to grasp the positions of the sequence number and the ACK number for each application.

### CITATION LIST

### Non Patent Literature

Non Patent Literature 1:https://pecolife.com/ping-down-onlinegame/
Non Patent Literature 2: https://pecolife.com/ping-down-onlinegame/

### SUMMARY OF INVENTION

### Technical Problem

Therefore, an object of the present invention is to continuously and easily grasp a communication quality such as an RTT of application communication itself without depending on a protocol type.

### Solution to Problem

A communication system of the present disclosure holds a DPI rule for each application in a DPI rule management server in advance, duplicates a packet of a designated application extracted based on a filtering rule for extracting the packet, extracts information from the packet based on a DPI rule for the application acquired from the DPI rule management server, and calculates a communication quality based on the extracted information.

A communication quality measurement method of the present disclosure includes: holding a DPI rule for each application in a DPI rule management server in advance; duplicating a packet of a designated application extracted based on a filtering rule for extracting the packet; extracting information from the packet based on a DPI rule for the application acquired from the DPI rule management server; and calculating a communication quality based on the extracted information.

A gateway device of the present disclosure holds a DPI rule for each application in a DPI rule management server in advance, duplicates a packet of a designated application extracted based on a filtering rule for extracting the packet, extracts information from the packet based on a DPI rule for the application acquired from the DPI rule management server, and calculates a communication quality based on the extracted information.

A program of the present disclosure is a program for implementing a computer as each functional unit included in a communication device according to the present disclosure, and is a program for causing a computer to execute each step included in a communication method executed by the communication device according to the present disclosure.

### Advantageous Effects of Invention

According to the present disclosure, it is possible to continuously and easily grasp a communication quality such as an RTT of application communication itself without depending on a protocol type.

### BRIEF DESCRIPTION OF DRAWINGS

FIG. 1 illustrates a system configuration example schematically illustrating the present disclosure.

FIG. 2 illustrates a configuration example of a system according to an embodiment.

FIG. 3 illustrates a configuration example of a terminal according to the embodiment.

FIG. 4 illustrates a configuration example of a home gateway according to the embodiment.

FIG. 5 illustrates a configuration example of an application server according to the embodiment.

FIG. 6 illustrates a configuration example of a DPI rule management server according to the embodiment.

FIG. 7 illustrates an example of a flow of update of a communication state table in the terminal.

FIG. 8 illustrates an example of a flow of request for measurement of a communication quality in the terminal.

FIG. 9 illustrates an example of a flow of measurement of the communication quality in the home gateway.

FIG. 10 illustrates an example of a flow of request for a DPI rule in the home gateway.

FIG. 11 illustrates an example of a flow of response to the DPI rule request in the DPI rule management server.

FIG. 12 illustrates an example of a flow of processing of the DPI rule request response in the home gateway.

FIG. 13 illustrates an example of a flow of information extraction in the home gateway.

FIG. 14 illustrates an example of a DPI rule table.

FIG. 15 illustrates an example of extracting information on a packet.

FIG. 16 illustrates an example of data stored in a packet data storage unit.

FIG. 17 illustrates an example of a flow of measurement of the communication quality in the home gateway.

FIG. 18 illustrates an example of calculating the communication quality.

FIG. 19 illustrates an example of a flow of display of the communication quality in the terminal.

### DESCRIPTION OF EMBODIMENTS

Hereinafter, embodiments of the present disclosure will be described in detail with reference to the drawings. Note that the present disclosure is not limited to the following embodiments. These embodiments are merely examples, and the present disclosure can be carried out in a form with various modifications and improvements based on the knowledge of those skilled in the art. Note that components having the same reference signs in the present specification and the drawings indicate the same components.

### Outline of Present Disclosure

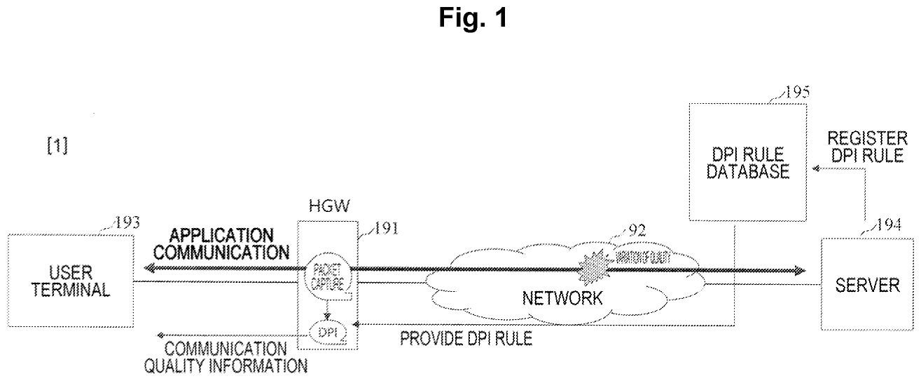

FIG. 1 illustrates a system configuration example schematically illustrating the present disclosure. In the system of the present disclosure, a DPI rule database 195 and a home gateway (HGW) 91 cooperate to perform DPI and present only a quality. Specifically, capture and DPI analysis are performed in a device of the HGW 91 on the basis of a DPI rule obtained from the DPI rule database 195, and only the analysis result is provided to the user terminal 193. In this way, an architecture is constructed in which a user can easily grasp a communication quality such as an RTT of application communication itself without depending on the type of an application and without an application provider disclosing packet header information.

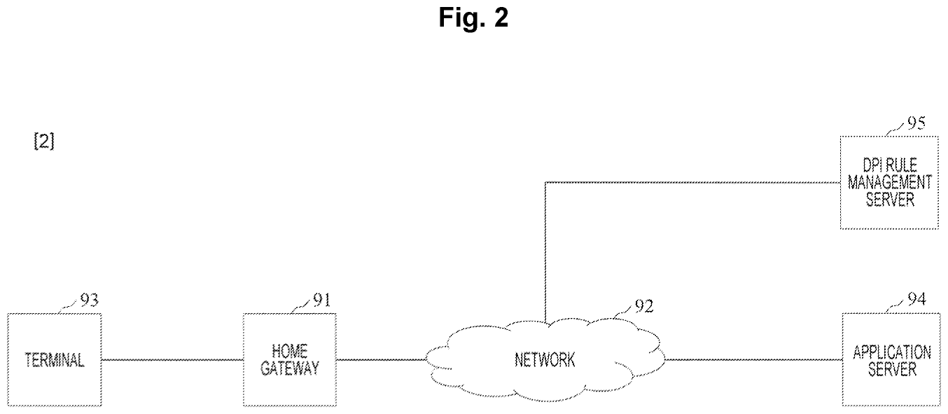

FIG. 2 illustrates a configuration example of a system according to an embodiment. In the system of the present disclosure, a terminal 93 communicates with an application server 94 via the home gateway (HGW) 91. In the system of the present disclosure, a DPI rule management server 95 is connected to the home gateway 91 via a network 92. The system of the present disclosure is a communication quality display system that drives the home gateway 91 and displays, on the terminal 93, the communication quality of an application being executed in the terminal 93. Each of the terminal 93, the home gateway 91, and the DPI rule management server 95 has the following functions.

The terminal 93 has a function of requesting the home gateway 91 to measure the communication quality.

Specifically, the terminal 93 has:
a filtering rule generation function of specifying a communication flow of an application whose communication quality is desired to be acquired when the user designates the application and generating a filtering rule;
a DPI rule request function of transmitting a signal requesting a DPI rule for analyzing a packet of the application to the DPI rule management server 95; and
a home gateway setting function of setting the home gateway 91 to analyze the communication quality on the basis of the DPI rule obtained by the DPI rule request function and the filtering rule.

The home gateway 91 has a function of measuring the communication quality in response to the request from the terminal 93. Specifically, the home gateway 91 has:
a DPI function of duplicating a packet extracted on the basis of the filtering rule and obtaining, in real time, time-series packet data obtained by extracting a header of the duplicated packet on the basis of the DPI rule; and
a communication quality display function of calculating communication quality information in real time from the time-series packet data obtained by the DPI function and displaying the communication quality information.

The DPI rule management server 95 has:
a DPI rule registration function of registering a DPI rule on the basis of a DPI rule registration signal from an application provider; and
a DPI rule response function of reading a DPI rule from a DPI rule database 53 on the basis of a DPI rule request signal transmitted from the terminal 93 and transmitting the DPI rule as a response signal to the terminal 93.

Since the system of the present disclosure has these DPI functions, the communication quality of the application being executed in the terminal 93 can be displayed on the terminal 93 in real time.

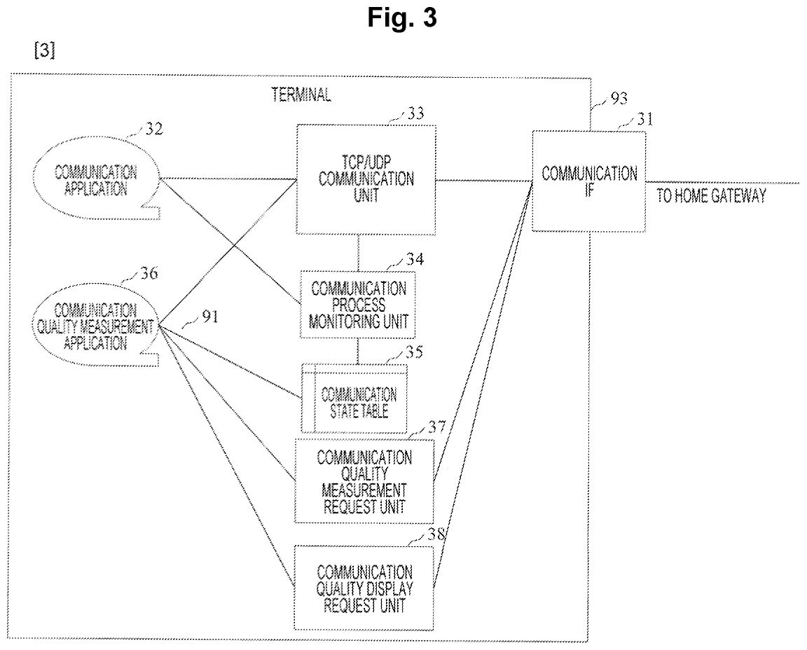

FIG. 3 illustrates a configuration example of the terminal 93 according to the embodiment. The terminal 93 includes a communication interface (IF) 31, a communication application 32, a TCP/UDP communication unit 33, a communication process monitoring unit 34, a communication state table 35, a communication quality measurement application 36, a communication quality measurement request unit 37, and a communication quality display request unit 38.

The communication interface (IF) 31 is communicably connected to the home gateway 91.

The communication application 32 executes an application provided by the application server 94.

The TCP/UDP communication unit 33 performs TCP/UDP communication with the application server 94.

The communication process monitoring unit 34 acquires the communication state of the TCP/UDP communication unit 33 and the name of the communication application 32, and registers, in the communication state table 35, the application name, an IP address used by the application, and a port number of TCP/UDP used by the application, which serve as communication state information. A method of acquiring the information on the TCP/UDP communication is not limited, and for example, in a case where the OS of the terminal 93 is windows, a netstat function can be used.

The communication state table 35 stores the communication state information including the IP address used by the application and the port number of TCP/UDP used by the application.

The communication quality measurement application 36 displays the information stored in the communication state table 35 on a display unit (not illustrated) of the terminal 93. When any piece of the displayed information is selected by the user, the communication quality measurement application 36 notifies the communication quality measurement request unit 37 of communication state information related to the selected application.

The communication quality measurement request unit 37 notifies the home gateway 91 of the communication state information of which the communication quality measurement application 36 has notified the communication quality measurement request unit 37, which serves as a communication quality request.

When receiving a request for acquiring the communication quality, the communication quality display request unit 38 transmits a communication quality acquisition request to the home gateway 91.

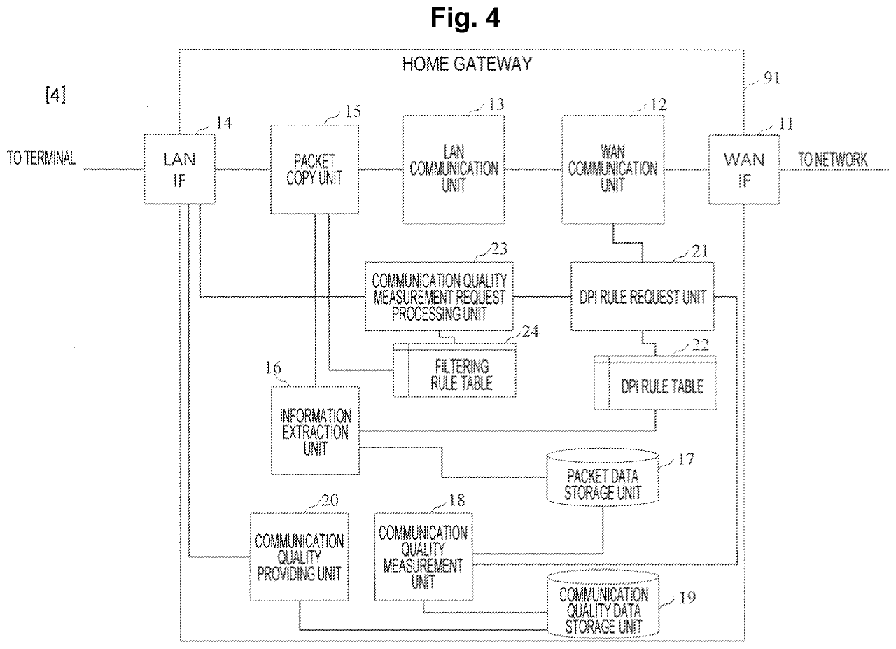

FIG. 4 illustrates a configuration example of the home gateway 91 according to the embodiment. The home gateway 91 includes a WAN IF 11, a WAN communication unit 12, a LAN communication unit 13, a LAN IF 14, a packet copy unit 15, an information extraction unit 16, a packet data storage unit 17, a communication quality measurement unit 18, a communication quality data storage unit 19, a communication quality providing unit 20, a DPI rule request unit 21, a DPI rule table 22, a communication quality measurement request processing unit 23, and a filtering rule table 24.

The WAN IF 11 is communicably connected to the network 92.

The WAN communication unit 12 communicates with the application server 94 via the network 92.

The LAN communication unit 13 performs LAN communication with the terminal 93.

The LAN IF 14 is communicably connected to the terminal 93.

The DPI rule request unit 21 transmits, to the DPI rule management server 95, a DPI rule request for requesting DPI rule information related to an application name of which the communication quality measurement request processing unit 23 has notified the DPI rule request unit 21.

The DPI rule table 22 stores DPI rule information described in a DPI rule request response.

The communication quality measurement request processing unit 23 registers information on the IP address and the port number of TCP/UDP in the communication quality request received from the terminal 93 in the filtering rule table 24.

The filtering rule table 24 stores the information on the IP address and the port number of TCP/UDP.

The packet copy unit 15 copies only a packet matching a filtering rule described in the filtering rule table 24, among packets transmitted and received by the home gateway 91, and transfers the copied packet to the information extraction unit 16.

The information extraction unit 16 extracts information from the information on the copied packet on the basis of the DPI rule described in the DPI rule table 22, and stores the extracted information in the packet data storage unit 17.

The packet data storage unit 17 stores the extracted information.

The communication quality measurement unit 18 measures the communication quality by using the extracted information stored in the packet data storage unit 17.

The communication quality data storage unit 19 stores the communication quality measured by the communication quality measurement unit 18.

When receiving the communication quality request from the terminal 93, the communication quality providing unit 20 provides the communication quality stored in the communication quality data storage unit 19 to the terminal 93 as a requestor.

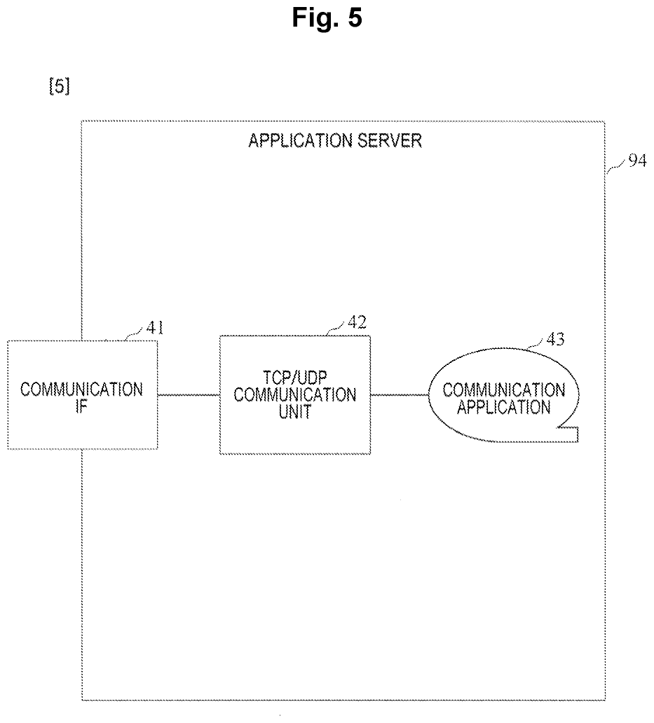

FIG. 5 illustrates a configuration example of the application server 94 according to the embodiment. The application server 94 includes a communication IF 41, a TCP/UDP communication unit 42, and a communication application 43.

The communication IF 41 is communicably connected to the network 92.

The TCP/UDP communication unit 42 communicates with the terminal 93 via the network 92.

The communication application 43 provides an application to the terminal 93 via the network 92.

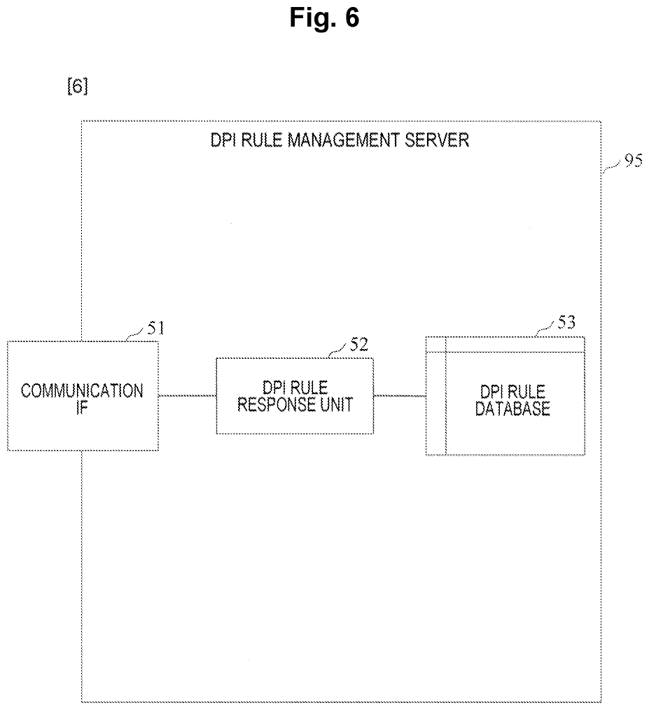

FIG. 6 illustrates a configuration example of the DPI rule management server 95 according to the embodiment. The DPI rule management server 95 includes a communication IF 51, a DPI rule response unit 52, and the DPI rule database 53.

The communication IF 51 is communicably connected to the network 92.

The DPI rule database 53 stores a DPI rule on the basis of a DPI rule registration signal from an application provider.

The DPI rule response unit 52 reads a DPI rule from the DPI rule database 53 on the basis of a DPI rule request signal transmitted from the terminal 93, and transmits the DPI rule as a response signal to the terminal 93.

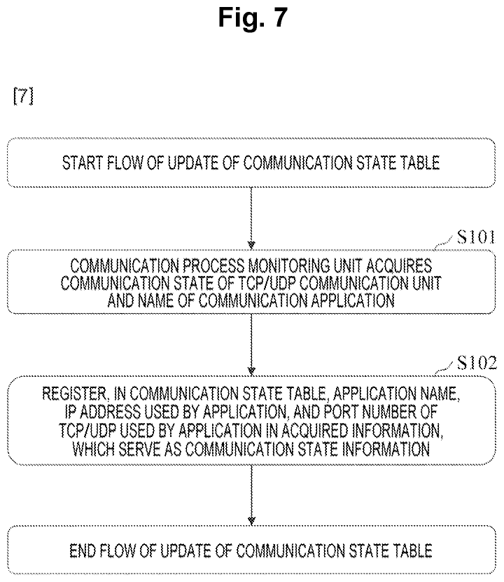

FIG. 7 illustrates an example of a flow of update of the communication state table in the terminal 93.

The communication process monitoring unit 34 acquires the communication state of the TCP/UDP communication unit 33 and the name of the communication application 32 (S101).

The communication process monitoring unit 34 registers, in the communication state table 35, the application name, the IP address used by the application, and the port number of TCP/UDP used by the application in the acquired information, which serve as communication state information (S102).

These steps of processing can be performed at any timing, and can be performed periodically.

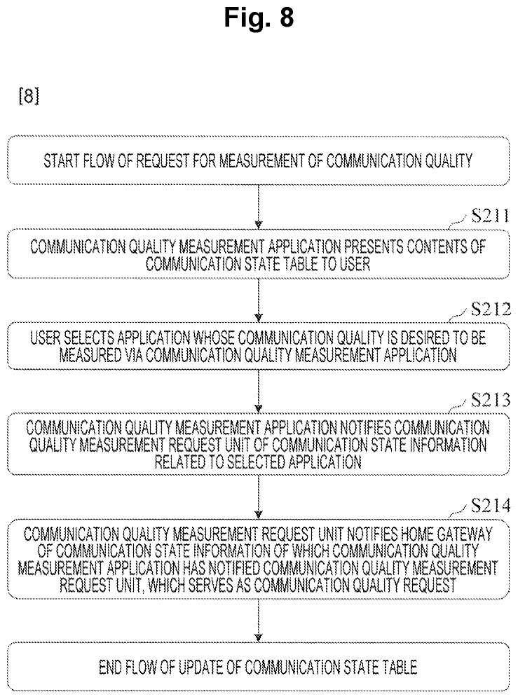

FIG. 8 illustrates an example of a flow of request for measurement of a communication quality in the terminal 93.

The communication quality measurement application 36 displays contents of the communication state table 35 on the display unit (not illustrated) of the terminal 93 (S211).

When the user selects an application whose communication quality is desired to be measured via the communication quality measurement application 36 (S212), the communication quality measurement application 36 notifies the communication quality measurement request unit 37 of communication state information related to the selected application (S213).

The communication quality measurement request unit 37 notifies the home gateway 91 of the communication state information of which the communication quality measurement application 36 has notified the communication quality measurement request unit 37, which serves as a communication quality request (S214).

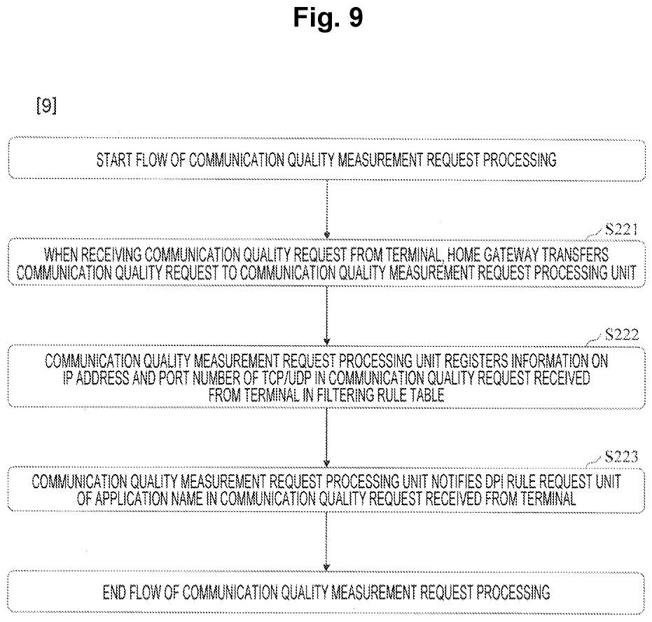

FIG. 9 illustrates an example of a flow of measurement of the communication quality in the home gateway 91.

When receiving the communication quality request from the terminal 93, the home gateway 91 transfers the communication quality request to the communication quality measurement request processing unit 23 (S221).

The communication quality measurement request processing unit 23 registers information on the IP address and the port number of TCP/UDP in the communication quality request received from the terminal 93 in the filtering rule table 24 (S222).

The communication quality measurement request processing unit 23 notifies the DPI rule request unit 21 of the application name in the communication quality request received from the terminal 93 (S223).

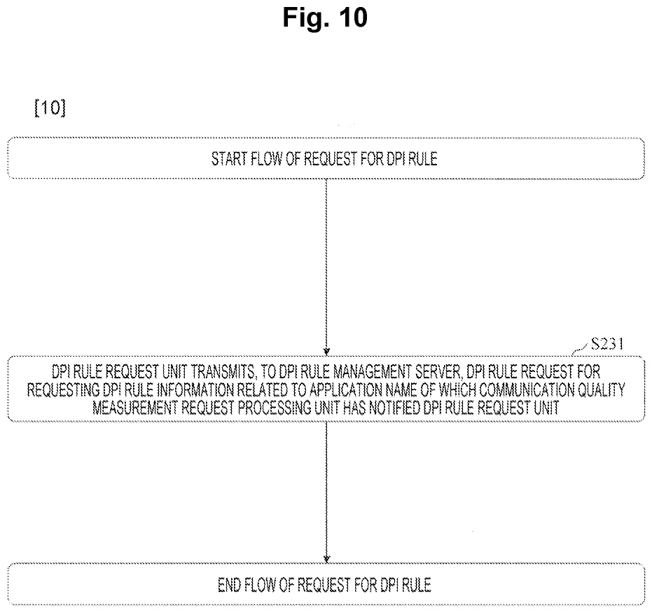

FIG. 10 illustrates an example of flow of request for a DPI rule in the home gateway 91.

The DPI rule request unit 21 transmits, to the DPI rule management server 95, a DPI rule request for requesting DPI rule information related to the application name of which the communication quality measurement request processing unit 23 has notified the DPI rule request unit 21 (S231).

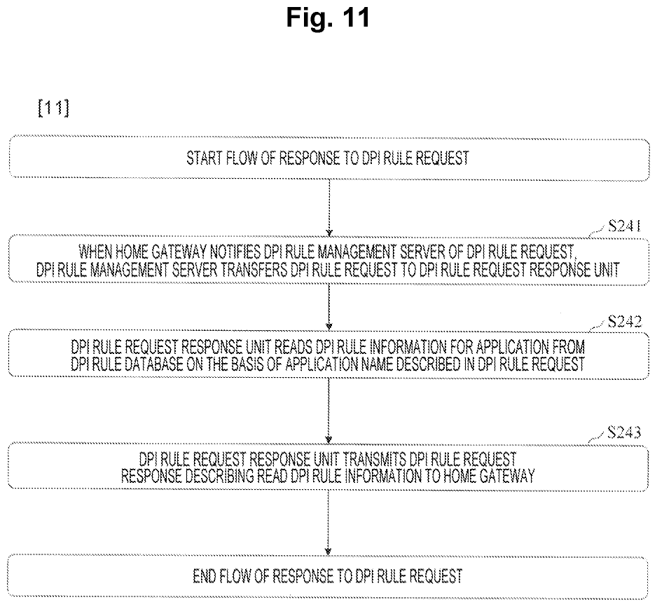

FIG. 11 illustrates an example of a flow of response to the DPI rule request in the DPI rule management server 95.

When the home gateway 91 notifies the DPI rule management server 95 of the DPI rule request, the DPI rule management server 95 transfers the DPI rule request to the DPI rule request response unit 52 (S241).

The DPI rule request response unit 52 reads DPI rule information for the application from the DPI rule database 53 on the basis of the application name described in the DPI rule request (S242).

The DPI rule request response unit 52 transmits a DPI rule request response describing the read DPI rule information to the home gateway 91 (S243).

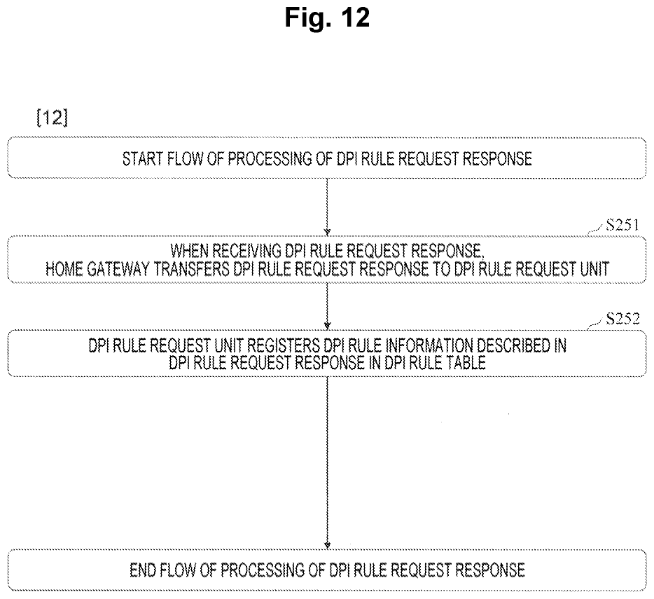

FIG. 12 illustrates an example of a flow of processing of the DPI rule request response in the home gateway 91.

When receiving the DPI rule request response, the home gateway 91 transfers the DPI rule request response to the DPI rule request unit 21 (S251).

The DPI rule request unit 21 registers the DPI rule information described in the DPI rule request response in the DPI rule table 22 (S252).

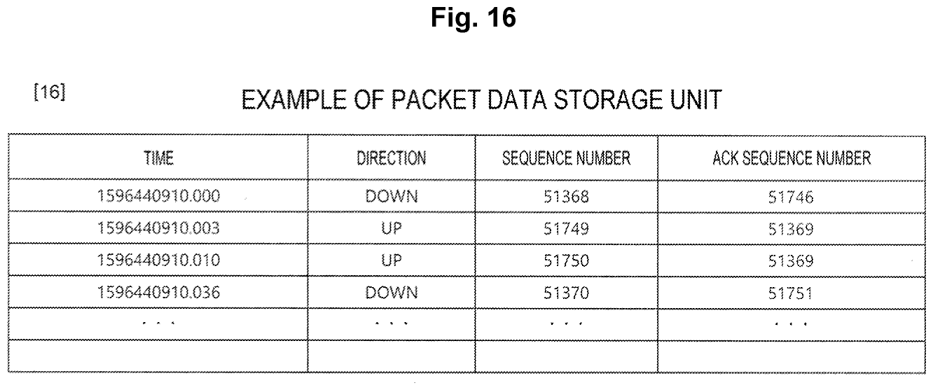

FIG. 16 illustrates an example of the DPI rule. The DPI rule includes an application, a start position, a sequence number position, a sequence number byte order, an ACK sequence number position, an ACK sequence byte order, and an ACK sequence rule.

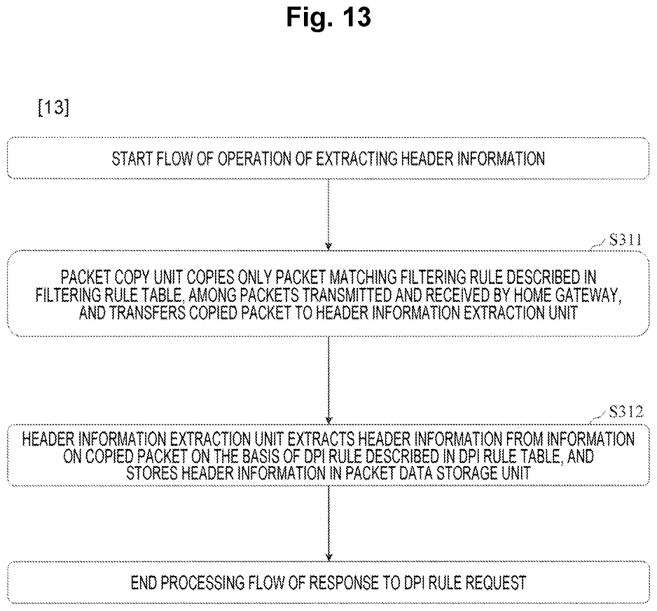

FIG. 13 illustrates an example of flow of information extraction in the home gateway 91.

The packet copy unit 15 copies only a packet matching a filtering rule described in the filtering rule table 24, among packets transmitted and received by the home gateway 91, and transfers the copied packet to the information extraction unit 16 (S311).

The information extraction unit 16 extracts information from the information on the copied packet on the basis of the DPI rule described in the DPI rule table 22, and stores the extracted information in the packet data storage unit 17 (S312).

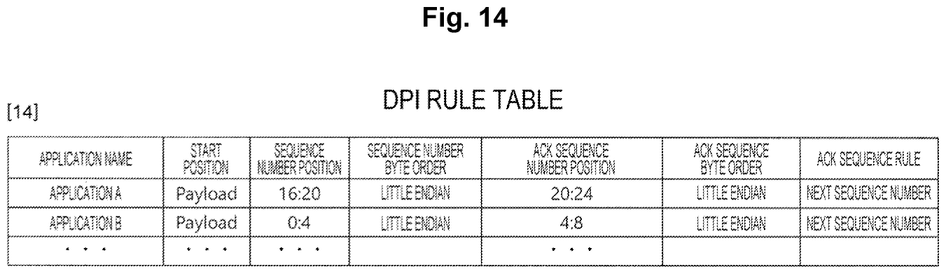

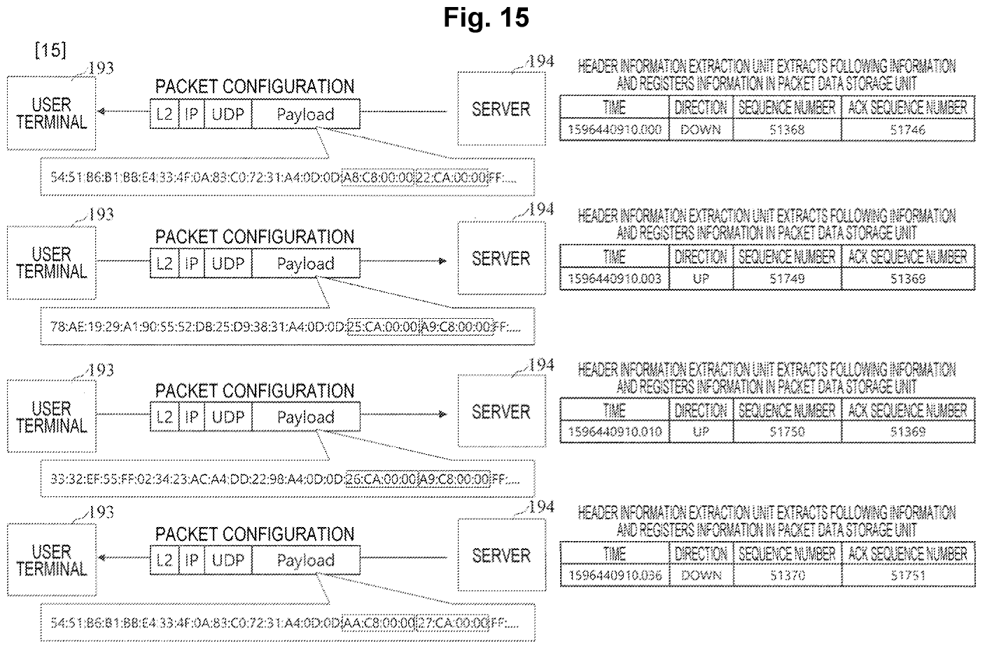

FIG. 14 illustrates an example of extracting information on the packet. For example, in a case where the DPI rule indicates information extraction from a payload as illustrated in FIG. 15, information defined by the DPI rule is extracted from the payload. FIG. 16 illustrates an example of data stored in the packet data storage unit 17.

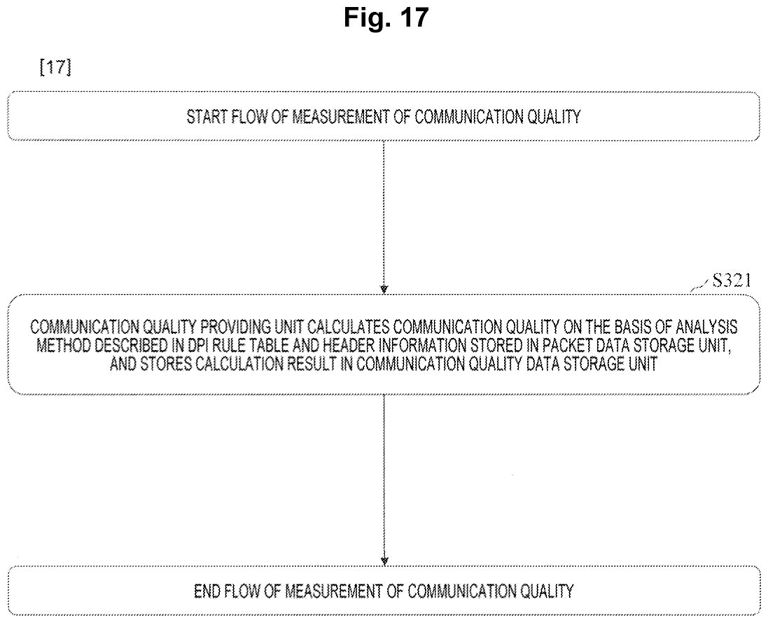

FIG. 17 illustrates an example of a flow of measurement of the communication quality in the home gateway 91.

The communication quality providing unit 20 calculates the communication quality on the basis of an analysis method described in the DPI rule table 22 and the extracted information stored in the packet data storage unit 17, and stores the calculation result in the communication quality data storage unit 19 (S321).

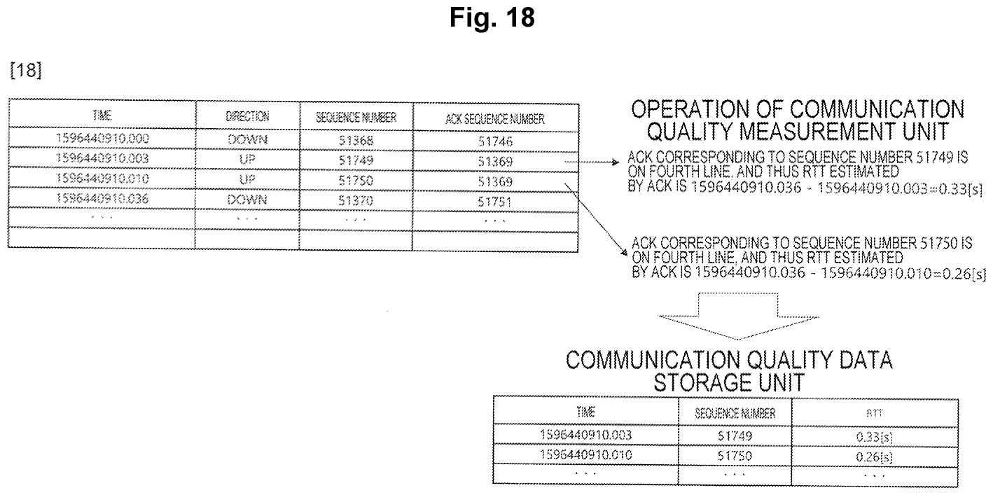

FIG. 18 illustrates an example of calculating the communication quality. For example, an RTT is calculated by use of a time and a direction of an ACK corresponding to a sequence number. If an ACK corresponding to a sequence number 51749 has a sequence number 51370, an RTT estimated by the ACK is 1596440910.036-1596440910.003=0.33 [s]. In addition, if an ACK corresponding to a sequence number 51750 has a sequence number 51370, an RTT estimated by the ACK is 1596440910.036-1596440910.010=0.26 [s].

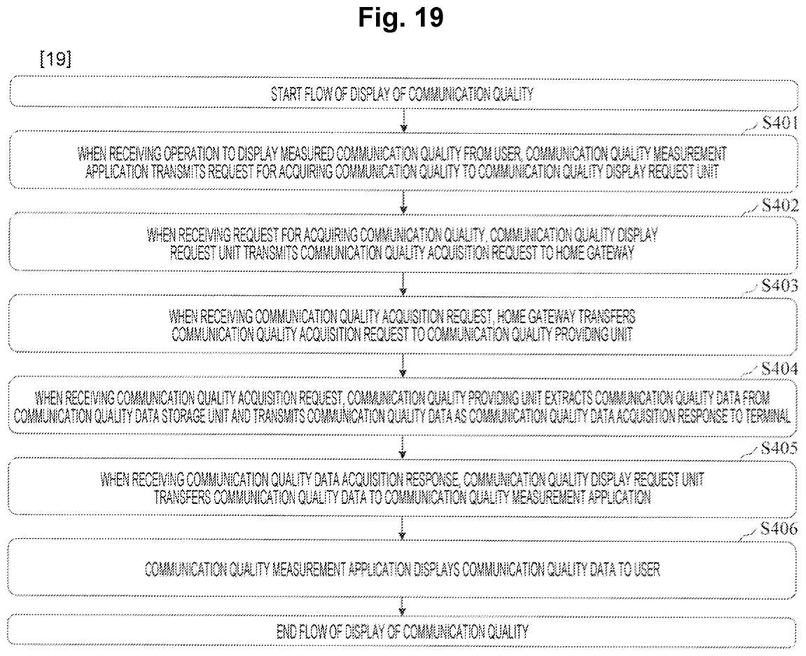

FIG. 19 illustrates an example of a flow of display of the communication quality in the terminal 93.

When receiving an operation to display the measured communication quality from the user, the communication quality measurement application 36 transmits a request for acquiring the communication quality to the communication quality display request unit 38 (S401). When receiving the request for acquiring the communication quality, the communication quality display request unit 38 transmits a communication quality acquisition request to the home gateway 91 (S402).

When receiving the communication quality acquisition request, the home gateway 91 transfers the communication quality acquisition request to the communication quality providing unit 20 (S403). When receiving the communication quality acquisition request, the communication quality providing unit 20 extracts communication quality data from the communication quality data storage unit 19 and transmits the communication quality data as a communication quality data acquisition response to the terminal 93 (S404).

When receiving the communication quality data acquisition response, the communication quality display request unit 38 of the terminal 93 transfers the communication quality data to the communication quality measurement application 36 (S405). The communication quality measurement application 36 displays the communication quality data on the display unit (not illustrated) included in the terminal 93 (S406). As a result, in the present embodiment, it is possible to grasp the communication quality of the application communication.

Here, in the present disclosure, information is extracted from a packet passing through the HGW 91, and the communication quality of the application communication is measured. Therefore, the present disclosure can continuously grasp the communication quality of the application communication without depending on the protocol type.

Furthermore, in the present disclosure, the user of the terminal 93 only needs to select communication state information related to the application. Therefore, in the present disclosure, it is possible to easily grasp the communication quality of the application communication.

Therefore, in the present disclosure, it is possible to continuously and easily grasp the communication quality such as the RTT of the application communication itself without depending on the protocol type.

Note that the device of the present invention can also be implemented by a computer and a program, and the program can be recorded in a recording medium or provided through a network.

### INDUSTRIAL APPLICABILITY

The present disclosure can be applied to the information communication industry.

### REFERENCE SIGNS LIST

11 WAN IF
12 WAN communication unit
13 LAN communication unit
14 LAN IF
15 Packet copy unit
16 Information extraction unit
17 Packet data storage unit
18 Communication quality measurement unit
19 Communication quality data storage unit
20 Communication quality providing unit
21 DPI rule request unit
22 DPI rule table
23 Communication quality measurement request processing unit
24 Filtering rule table
31 Communication interface (IF)
32 Communication application
33 TCP/UDP communication unit
34 Communication process monitoring unit
35 Communication state table
36 Communication quality measurement application
37 Communication quality measurement request unit
38 Communication quality display request unit
41 Communication IF
42 TCP/UDP communication unit
43 Communication application
51 Communication IF
52 DPI rule response unit
53 DPI rule database
91, 191 Home gateway (HGW)
92 Network
93 Terminal
94 Application server
95 DPI rule management server
193 User terminal
194 Server
195 DPI rule database

1. A communication system that
holds a DPI rule for each application in a DPI rule management server in advance,
duplicates a packet of a designated application extracted based on a filtering rule for extracting the packet,
extracts information from the packet based on a DPI rule for the application acquired from the DPI rule management server, and
calculates a communication quality based on the extracted information.

2. A communication quality measurement method performed by a gateway device, the communication quality measurement method comprising:
holding a DPI rule for each application in a DPI rule management server in advance; duplicating a packet of a designated application extracted based on a filtering rule for extracting the packet; extracting information from the packet based on a DPI rule for the application acquired from the DPI rule management server; and calculating a communication quality based on the extracted information.

3. A gateway device that
holds a DPI rule for each application in a DPI rule management server in advance, duplicates a packet of a designated application extracted based on a filtering rule for extracting the packet, extracts information from the packet based on a DPI rule for the application acquired from the DPI rule management server, and calculates a communication quality based on the extracted information.

4. A non-transitory computer-readable medium having computer-executable instructions that, upon execution of the instructions by a processor of a computer, cause the computer to function as the gateway device according to claim 3.
